(19) United States
(12) Patent Application Publication
(10) Pub. No.: US 2005/0160658 A1
(43) Pub. Date: Jul. 28, 2005

(54) Fishing lure

(76) Inventor: Andrzej Buczkowski, Elizabeth, NJ (US)

Correspondence Address: WILLIAM R. MORAN, SUITE 909, 333 EAST 43RD STREET, NEW YORK, NY, 10017, US

(21) Appl. No.: 10/764,673

(22) Filed: Jan. 24, 2004

(51) Int. Cl. A01K 85/00

(52) U.S. Cl. 43/42.06; 43/42.36; 43/42.24

(57) ABSTRACT

A fishing lure is provided for attracting and catching fish which is in the form of a sleeve with a hook, at the rear end and the front end of which has means to which the sleeve is attached for allowing the sleeve to swivel around a central axis and when the lure is dragged through the water it gives the appearance of a life-like movement of the lure. One are more hook are concealed within the sleeve and when the lure is pulled through the water the sleeve undulates or moves in such a manner as to give the impression that the lure is alive.

### BACKGROUND OF THE INVENTION

1) Field of the Invention

This invention relates to a device used in fishing and particularly to lure for attracting and catching fish.

2) Related Art

A person visiting any hardware or department store which stocks fishing supplies and fishing equipment, will be amazed by the wide variety of items available for purchase and useful for attracting and catching fish. In particular, numerous lures, flies, and hooks and combinations thereof are available in all sizes, shapes, colors and designs which are promoted as the ultimate devices for catching fish. Many expert and seasoned fishermen make their own lures in the form of flies, bugs and the like.

The patent literature is replete with a wide variety of fishing lures which are almost guaranteed to attract fish. For example, U.S. Pat. No. 6,122,854 which issued Sep. 26, 2000, discloses a fishing lure whose direction of travel is controlled by a steering lip. When the fishing line is jerked by the user, the direction of travel of the lure can be varied.

U.S. Pat. No. 5,960,580 which issured Oct. 5, 1999, is directed to wrapped lure skirt sand a method of manufacture. Also of interest is U.S. Pat. No. 6,058,645, which issued on May 9, 2000 to MIchael G. Lummins and which discloses an elongated fishng lure with a boyant material core and a body encasing the core.

In U.S. Pat. No. 6,418,659B1, which issued Jul. 16, 2002, to Michael Shelton there is disclosed a fishing lure skirt and method. The skirt is prepared from a flat blank of cured elastomer having head and tail filaments. A strip of solid tacky uncured is applied to the head and wrapped around a cylindrical mandrel to form a tubular head which is then cured by the application of heat.

Of particular interest is U.S. Pat. No. 5,950,345, which issued Sep. 14, 1999, to Holgar Kilander and discloses and claims a streamer device which is used as a fishing lure. The fishing lure of this invention contains ribbons which are removably attached to a collar and which extend past the trailing edge of the collar. It is also noted that the ribbons are transparent in water and can contain indicies in the form of bait or fish. When the lure is pulled through the water it gives the life-like impression of a whole school of small fish swimming together. Thus, at first glance the lure of this patent appears to be pertinent to the present invention. However, upon closer inspection there are marked differences. In the present invention the lure is comprised of not a plurality of ribbons but a sleeve. In contrast to the prior the present sleeve is not transparent in water nor does it contain indicies of fish. When pulled through the water the lure of the present invention moves or undulates as a unit and not as separate flaps or ribbons each of which moves separately friom one another. Thus, while the prior art lure may provide the impression of a school of small fish swimming through the water, the lure of the present invention can give the impression of a variety of creatures, including bugs, insects, tadpoles and the like depending upon the configuration.

It is therefore and object of this invention to provide a fishing lure which is uniquely fashioned to attract and catch fish. Another object of this invention is to provide a lure which when pulled through the water undulates or exhibits movement of the lure itself suggesting that it is alive. A still further object of the present invention is to provide a lure comprised of a sleeve portion which conceals one or more hooks and is comprised of a flexible matieral or fabric which moves as the lure is pulled through the water. Another object is to provide a lure which when moved through the water can give the impression of a small fish, jellyfish, frog, or ther live creature. A still further object is th provde a lure which can swival at the end of a fishing line adding to the appearance of a live fish or other creature. These and othr objects will readily become apparent to those skilled in the art in light of the teachings herein set forth.

### DESCRIPTION OF THE DRAWINGS

FIG. 1 is a perspective view of one embodiment of the lure of the present invention.

FIG. 2 is a perspective view of a portion of the interioir of the lure of FIG. 1 without the exterior body sleeve covering.

FIG. 3 is a perspective view depectig the lure of FIG. 1 with the body sleeve covering the lower portion of the lure.

FIG. 4a, 4b, 4c, and 4d are perspective views of typical exterior configuration of the lure and sleeve.

### SUMMARY OF THE INVENTION

In its broad aspect, the present invention is directed to a fishing lure for attracting and hooking fish. The lure is comprised of, in combination:

(a) a sleeve body open at both front and back ends and comprised of a flexible, thin material which undulates when the lure is pulled through the water,

(b) hook means disposed within or extending from the back end of the sleeve body,

(c) means for attaching the lure to a fishing line and for attachment of the sleeve and hook means.

### DETAILED DESCRIPTION OF THE PREFERED EMBODIMENTS

The invention will be more readily understood by reference to the drawings wherein:

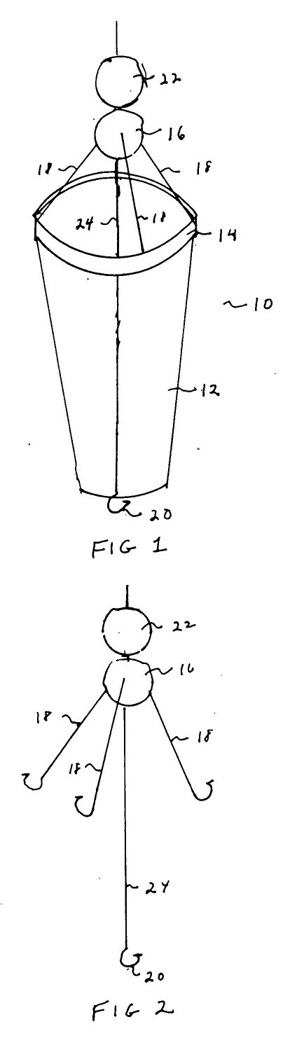

FIG. 1 is a view of lure 10 of the present invention having sleeve body 12 attached by its top from edge to ring 14. Ring 14 in turn is attached to holder 16 by at least two, and preferably three or more lines 18. Holder 16 supports hook extension 20 located at the back end of sleeve 12. Holder 16 is in turn is attached to item 22 for engagement with a fishing line, not shown. The attachment of holder 16 to item is such so the holder can swivel 360 degrees around item 22. When lure 10 is pulled through the water sleeve body 12, which is comprised of a thin flexible material, will undulate or be in motion giving the impression of a live creature.

FIG. 2 is a perspective view of lure 10 without sleeve 12 and showing holder 16 with four lines 18 extending there from and for attachment to the front edge of sleeve 12. Holder 16 has at its lower center, hook 20 which extends through the interior of sleeve 12. Hook 20 can be attached through item 24 to holder 16. Also, at the upper end of holder 16 is item 22 which can swivel around holder 16 and provide means for attachment of a fishing line, not shown.

Lines 18 can terminate in hooks 26 which can be attached directly to the front edge of the sleeve material at a plurality of positions. Alternatively, as indicated above, a the from end of sleeve 12 can terminate in a ring, such as a metal ring, to which lines 18 can be attached.

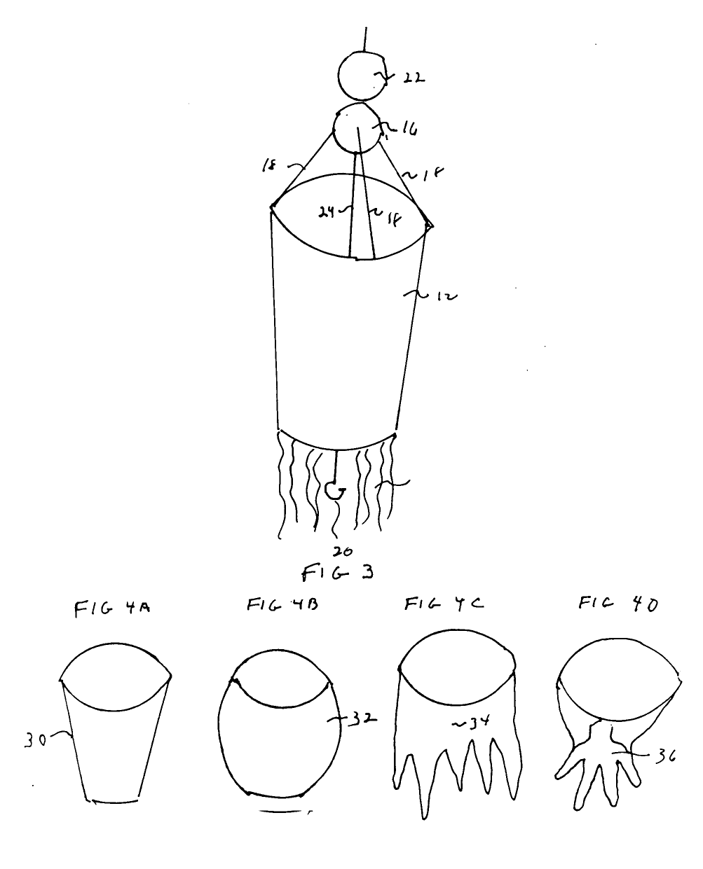

FIG. 3 is another perspective view of lure 10 showing sleeve 12, holder 16 and lines 18. At the back edge of sleeve 12, a plurality of flexible strings or ribbons can be attached thereto to hide hook 20. While sleeve 12 can extend to cover lines 18 and most of holder 16, FIG. 3 shows lure 10 which is partially covered by sleeve 12. FIG. 4a, FIG. 4b, FIG. 4c and FIG. 4d are views of a variety of configurations of sleeve 12. FIG. 4a depicts a sleeve which is conical in shape 30. FIG. 4b of shape 32 has a shape like a football, that is the center section is wider that either of the front or rear sleeve edges. Fir 4c depicts a sleeve 34 in the form of a jelly fish or hydra, and FIG. 4d has the sleeve in the shape of a tadpole or small frog. Other configurations of sleeve 12 can be made to imitate the shape 36 of beetles, bugs and a wide variety of creatures which present themselves as a good meal for fish.

I is evident from the above, that the sleeve of lure 10 can be fabricated from a wide variety of materials and fabric, the only requirement being that the materiel or fabric is flexible and is not water soluble. The sleeve can be configured in a wide variety of shapes and sizes. Depending upon the type of fishing, the lure can be of a very small size, or of a much greater size for salt water fishing. In practice, the sleeve can be comprised of silk, rayon, cellulose, cotton, cotton blends, linen, synthetic materials, polymeric materials, such as polyethylene or polypropylene film, and even some organic materials, such as seaweed, fish skin, and the like. It is therefore evident that the sleeve can be comprised of a variety of materials as long as the material undulates or moves, for example, in wave-like motions when the lure is pulled through the water.

Although several of the drawings depict lures where hook 20 extends beyond the back edge of sleeve 12, in practice, the hook 20 is preferably contained within the sleeve so as not to be visible to the fish in its pursuit of the lure as it is dragged through the water. However, FIG. 3 depicts one embodiment wherein the hook is hidden by ribbons or strands of yam even though hook 20 extends beyond the end of the sleeve.

The other items of which the lure is comprised can be fabricated from a wide variety of materials which are customarily employed in the fishing industry. It is, of course, important that the materials be of sufficient strength to withstand the pull of the fish once it is hooked, The sleeve itself is merely for providing the appearance of motion or undulation so that the lure will appear to be alive and does not contribute strength to the lure.

It is an important feature of the present invention that the holder 20 and item 22 as well as hook xx be capable of swiveling around their attachment points to the rest of the lure to assist in giving a life-like appearance to the lure as it goes through the water.

Although the invention has been illustrated by the various embodiments and drawings, it is not to be construed as being limited to the materials employed therein, but rather, the invention is directed to the generic area as herein before disclosed, various modifications and embodiments thereof can be made without departing from the spirit and scope thereof.

1. A fishing lure, useful for attracting and catching fish, comprised of, in combination
(a) A sleeve open at both front and rear ends and comprised of a flexible, thin material which undulates when the lure is pulled through the water,
(b) hook means disposed within and near the rear end of the sleeve, and
(c) means which can be attached to a fishing line and for attachment of of said sleeve and hook means.

2. The fishing lure of claim 1 wherein the sleeve is comprised of an essentially water insoluble material.

3. The fishing lure of claim 1 wherein the sleeve is shaped like a football with the center portion being wider that either the front or rear ends.

4. The fishing lure of claim 1 wherein the sleeve is cylindrical in shape.

5. The fishing lure of claim 1 wherein the sleeve is in the shape of a cone.

6. The fishing lure of claim 1 wherein the sleeve is in the shape of a bug

7. The fishing lure of claim 1 wherein the sleeve is the the shape of a frog.

8. The fishing lure of claim 1 wherein the sleeve and hook are attached so that they can swivel at opposite ends of a holder, which has means for attachment of fish line.

9. The fishing lure of claim 8 wherein the holder has a plurality of arms which attach to the front circumferential end of the sleeve.

10. The fishing lure of claim 9 wherein the arms are attached to a ring to which is attached the front circumferential end of the sleeve.

11. The fishing lure of claim 9 wherein the holder is spherical in shape and the arms are selected from the group consisting of flexible metal wire, plastic wire and fabric.

12. The fishing lure of claim 11 wherein the hook and fish line attachment means can swivel about the holder.

13. The fishing lure of claim 11 wherein the hook is disposed just inside the rear end of the sleeve.

14. The fishing lure of claim 11 wherein the hook protrudes beyond the rear end of the sleeve.

15. The fishing lure of claim 11 wherein wherein the protruded hook and is hidden by a plurality of ribbons, one end of which is attached to the rear end of the sleeve.

16. The fishing lure of claim 2 wherein the sleeve is comprised of a material selected from the group consisting of silk, rayon, cotton, cotton blends, linen, nylon, polyethylene, polypopylene, and mixtures thereof.

17. The fishing lure of claim 16 wherein the sleeve is comprised of silk.

18. The fishing lure of claim 16 wherein the sleeve is comprised of rayon.

19. The fishing lure of claim 16 wherein the sleeve is comprised of polyethylene film.

20. A fishing lure, useful for attracting and catching fish, comprised of, in combination:
(a) a thin, silk, cylindrical sleeve open at both the front and rear ends, which undulates when the lure is pulled through the water,
(b) a solid, spherical shape holder which has an extension on its upper surface which can swivel with respect to the holder and to which a fishing line can be attached, and the bottom surface of which has an extension which can swivel with respect to the holder, and to which is attached at least one hook,
(c) a plurality of arms extending from the spherical holder to engage an retain a ring disposed in the front end of the sleeve.
